(19) United States
(12) Patent Application Publication
(10) Pub. No.: US 2026/0235032 A1
(43) Pub. Date: Aug. 13, 2026

(54) A ROTOR, A POWER-GENERATION TURBOMACHINE COMPRISING SAID ROTOR, AND A THERMODYNAMIC CIRCUIT USING SAID TURBOMACHINE

(71) Applicant: Nuovo Pignone Tecnologie - S.r.l., Florence (IT)

(72) Inventors: Gabriele GIREZZI, Firenze (IT); Giacomo RAGNI, Firenze (IT); Paolo DI SISTO, Firenze (IT); Damaso CHECCACCI, Firenze (IT); Lorenzo COSI, Firenze (IT); Enrico GIUSTI, Firenze (IT); Fabio VALERI, Firenze (IT)

(21) Appl. No.: 19/471,028

(22) PCT Filed: Mar. 26, 2024
(86) PCT No.: PCT/EP2024/025130

§ 371 Date: Sep. 30, 2025

(30) Foreign Application Priority Data
Mar. 31, 2023 (IT) 102023000006348

(51) Int. Cl. F01D 5/06; F01D 25/12

(52) U.S. Cl. CPC F01D 5/06; F01D 25/12; F05D 2260/213

(57) ABSTRACT

Disclosed herein is a rotor comprising a set of rotor disks. Each rotor disk comprises a respective annular row of rotor blades. The rotor further comprises a forward shaft portion and an aft shaft portion. A first set of rotor disks is formed integrally with a section of one of said forward shaft portion and aft shaft portion. Said section of the shaft portion and the first set of rotor disks form a monolithic component. Moreover, the forward shaft portion and the aft shaft portion are connected to one another by a tie rod arrangement.

### TECHNICAL FIELD

The present disclosure concerns gas expanders particularly adapted for use in oxy-fuel power cycles operating with process gas at high pressures, for instance CO₂ cycles, such as Allam cycles, aka NET Power cycles. More in general, the present disclosure concerns rotors for power-generating turbomachines and turbomachines including said rotors.

### BACKGROUND ART

Fossil fuels are a major source of chemical energy used for the generation of mechanical power. Fossil fuels are mixed with air and combusted to generate a combustion gas at high pressure and temperature, which expands in a turbine or a expander. The expander converts combustion gas enthalpy into mechanical power available on the output shaft of the expander and used to drive a load, such as a compressor or compressor train, or to rotate an electric generator and convert mechanical power into electric power.

One of the major concerns regarding combustion of fossil fuels relates to the production of carbon dioxide, a greenhouse gas which is considered one of the main contributors of global warming and climate changes.

To reduce the environmental impact of power generation through combustion of fossil fuels, the option of post combustion capture of carbon dioxide has been investigated. Carbon dioxide capture facilities have been developed, to process flue gas exhausted from gas turbines and remove carbon dioxide therefrom, prior to discharging the flue gas in the environment. The cost of a carbon dioxide capturing facility is high, both in term CAPEX, as well as in terms of energy required to run the facility, which reduces the overall thermodynamic efficiency of the system. The percentage of carbon dioxide in flue gas is low. This requires large volumes of flue gas to be processed through the carbon dioxide capturing facility and renders the capturing process particularly inefficient.

In recent years oxy-combustion cycles, also known as oxy-fuel cycles, have been developed, wherein fuel, such as natural gas or another fossil fuel, is blended into a mixture of an oxidant consisting mainly of oxygen (O₂) and carbon dioxide (CO₂) at high pressure. The blend of fuel, oxygen and carbon dioxide burns in a combustor of an expander producing a pressurized flue gas consisting exclusively or almost exclusively of carbon dioxide and water.

The flue gas is expanded in the expander to generate mechanical power. The exhausted flue gas discharged at the discharge side of the expander is cooled in a regenerative heat exchanger and further chilled to condensate water which can thus be removed from the chilled flue gas. The low-temperature flue gas, consisting mainly or exclusively of carbon dioxide is pressurized and recycled through the regenerative heat exchanger towards the combustor of the expander.

Oxygen supplied to the combustor of the expander can be obtained by separation from ambient air, removing nitrogen therefrom, such that the working fluid supplied to the combustor mainly consists of oxygen and carbon dioxide and does not include nitrogen. The resulting flue gas mainly consists of water and carbon dioxide. Water is removed from the flue gas by condensation and the part of water-free flue gas, which is not recycled to the combustor, can be efficiently processed in a carbon dioxide capturing unit.

The oxy-fuel cycle summarized above is a semi-closed cycle, in that only a fraction of the flue gas exits the cycle after water has been removed therefrom.

Oxy-fuel or oxy-combustion cycles, such as those described above, are particularly interesting in terms of efficiency and reduction of noxious emissions. However, they operate under CO₂ supercritical conditions at the inlet of the expander and are characterized by a high pressure drop across the expander and a high torque applied to the rotor of the expander. These factors become critical and raise serious challenges in the expander rotor design, when the rated power of the expander increases, and may pose limitations to the maximum power rate of the expander.

A novel rotor and turbomachine design adapted to achieve higher power rates, for instance in an oxy-fuel cycle, would be welcomed in the art.

### SUMMARY

According to one aspect, disclosed herein is a rotor for a power-generating turbomachine, such as in particular for an expander or turboexpander. In some embodiments, the expander is an oxy-fuel combustion expander, adapted to process supercritical carbon dioxide at the inlet of the expander, for instance.

In embodiments disclosed herein, the rotor comprises a set of rotor disks and each rotor disk comprises a respective annular row of rotor blades. The rotor blades can be integrally formed with the respective rotor disk or can be manufactured as separate components subsequently mounted on the rotor disk. The rotor further comprises a forward shaft portion and an aft shaft portion. A first set of rotor disks is formed integrally with a section of the forward shaft portion. Said section of the forward shaft portion and the first set of rotor disks form a monolithic component. Moreover, the forward shaft portion and the aft shaft portion are connected to one another by a tie rod arrangement. The first set of rotor disks can include one rotor disk or a plurality of rotor disks.

An additional set of rotor disks can be formed integrally with the other of said forward shaft portion and aft shaft portion. Said other of said forward shaft portion and aft shaft portion, and the additional set of rotor disks form in turn a monolithic component. The additional set of rotor disks can include one rotor disk or a plurality of rotor disks.

In some embodiments, the rotor can include at least one additional rotor disk, and preferably a plurality of additional rotor disks, positioned between the forward shaft portion and aft shaft portion. The forward shaft portion, the additional rotor disks and the aft shaft portion are stacked to one another and connected to one another by the tie rod arrangement.

In some embodiments, the first set of rotor disks is integrally formed with the forward shaft portion and a plurality of additional rotor disks is positioned between the forward shaft portion and the aft shaft portion. The forward shaft portion, the plurality of rotor disks and the aft shaft portion are stacked to one another and connected to one another by the tie rod arrangement.

According to another aspect, disclosed herein is a power-generating turbomachine, such as an expander, for instance, including a rotor as outlined above and described in more detail here below. In embodiments disclosed herein, the turbomachine is an expander, and may be a supercritical CO₂ expander, i.e., an expander wherein the carbon dioxide is in supercritical conditions at the inlet of the expansion flow path, and/or an expander for an oxy-fuel combustion cycle, such as an Allam cycle.

Additional features of the rotor and of the turbomachine are set forth in the dependent claims.

### BRIEF DESCRIPTION OF THE DRAWINGS

Reference is now made briefly to the accompanying drawings, in which:

FIG. 1 is a schematic of an oxy-fuel power circuit;

FIG. 2 is a sectional view of an expander in one embodiment; and

FIG. 3 is a sectional view of a portion of a rotor for the expander of FIG. 2, in a further embodiment.

### DETAILED DESCRIPTION

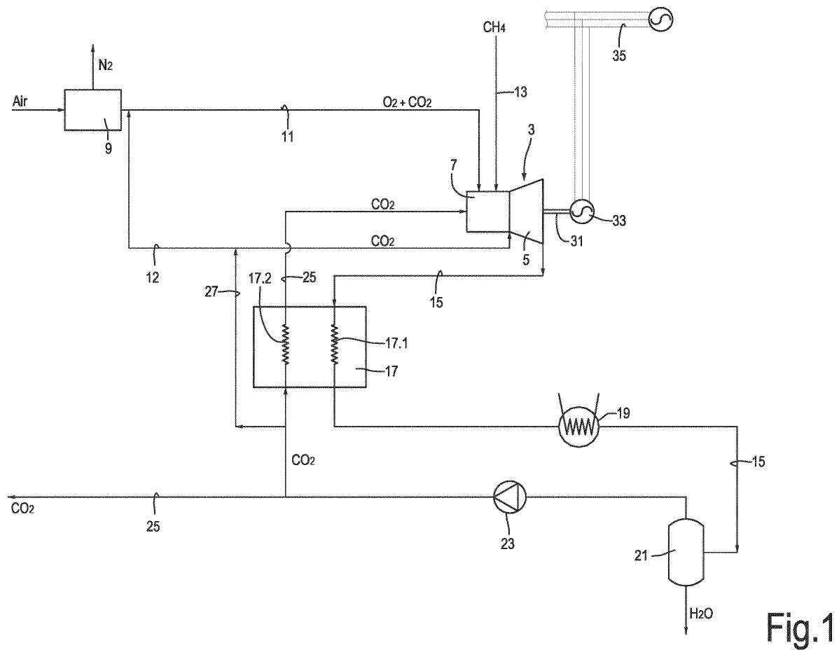

The schematic of FIG. 1 illustrates a simplified supercritical carbon dioxide cycle (shortly sCO₂ cycle), such as an Allam cycle or a similar oxy-fuel combustion cycle, in which the use of an expander including a rotor according to the present disclosure can be particularly beneficial. In general terms, a supercritical carbon dioxide cycle as understood herein is a cycle wherein carbon dioxide is in a supercritical condition at least at the inlet of the expansion flow path in the expander.

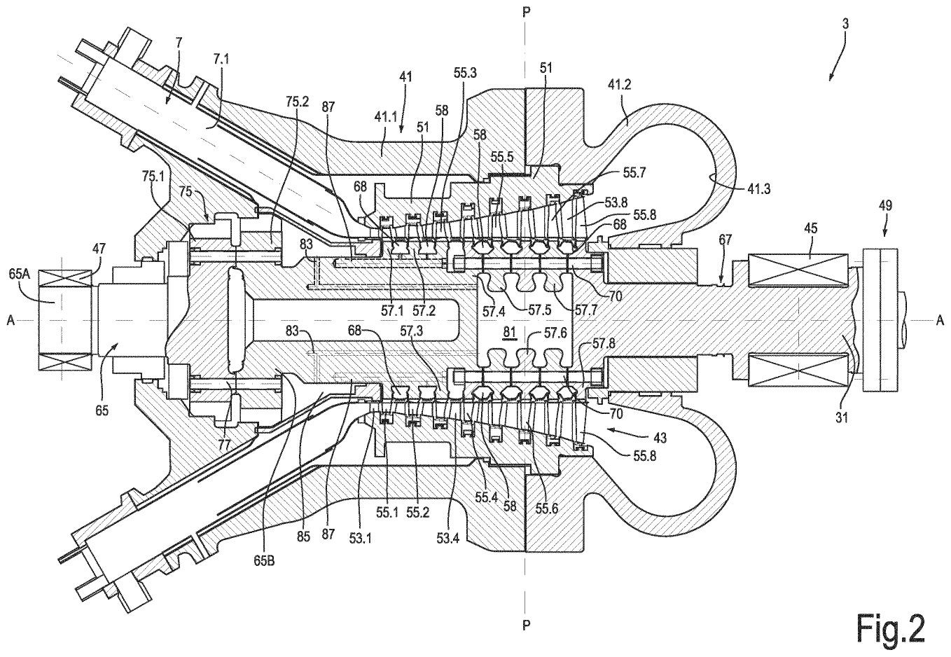

The power system 1 shown in FIG. 1 comprises an expander (aka turboexpander) 3 that includes an expansion section 5 and a combustor 7. The combustor 7 can be an annular combustor, a can-type combustor, a can-annular combustor, or the like, for instance. In currently preferred embodiments, the combustor is a can-type combustor comprising a plurality of combustion chambers arranged around the rotation axis of the expander 3, as shown in more detail in FIG. 2. In some embodiments, as schematically shown in FIG. 1, the combustion chambers are housed in a high-pressure casing of the expander. In some embodiments, each combustion chamber is housed in a respective seat formed in a high-pressure casing of the expander, as will be described in more detail below.

Reference number 7.1 in FIG. 2 designates single combustion chambers of a can-type combustor or can annular combustor. In other embodiments, not shown, the combustor can be an annular combustor, as mentioned.

The combustor 7 is supplied with an oxidant flow delivered by an oxidant source. The oxidant may be oxygen (O₂) or a blend comprising, or mainly consisting of oxygen and carbon dioxide (CO₂). The oxidant flow can be produced by an air separation unit 9, which features an oxidant source. The air separation unit 9 may remove nitrogen or nitrogen and carbon dioxide from ambient air to produce the required oxidant stream which is supplied through an oxidant line 11 to the combustor 7 of the expander 3. In some embodiments, for the sake of easier handling of the oxidant flow, the latter may include around 20% in volume of oxygen and 80% in volume of carbon dioxide. The CO₂ and O₂ percentages mentioned above are by way of example. The carbon dioxide can be added to the oxygen through a recycling line 12, as explained in more detail below.

Reference number 13 indicates a fuel supply line, for instance adapted to supply natural gas, such as methane, to the combustor 7, specifically to each combustion chamber 7.1 thereof. The oxidant and the fuel are supplied at the inlet side of the expander 3 to the combustor 7 at high pressure. The upper pressure of the thermodynamic cycle can be for instance 50 barA or above, preferably 100 barA or above, for instance around or above 200 barA, preferably around or above 250 barA, or higher, for instance equal to or higher than 300 barA. In general, the pressure can be below 800 barA, or lower than 650 barA. In some embodiments, the upper pressure of the thermodynamic cycle, i.e. the pressure in the combustor and at the first expansion stage can be 100, 150, 200, 250, 300, or 350 barA.

The oxidant-fuel blend is burned in the combustor 7. Pressurized, hot combustion gas resulting from the combustion expands in the expansion section 5 of the expander 3. The temperature at the exit side of the stationary nozzles downstream the combustor, i.e. at the inlet of the expander rotor, can be comprised between 800° C. and 1500° C., for instance.

The exhausted flue gas is discharged after expansion at a discharge side of the expander 3 in a discharge line 15. The flue gas in the discharge line 15 can be at a temperature between about 400° C. and about 700° C., for example around 600° C., and at a pressure which may range between about 10 barA and about 100 barA, preferably between about 20 barA and about 60 barA.

The circuit further comprises a regenerative heat exchanger 17, wherein hot flue gas flowing through a hot side 17.1 of the regenerative heat exchanger 17 is cooled in heat exchange with a flow of chilled flue gas which flows through a cold side 17.2 of the regenerative heat exchanger 17. The flue gas discharged from the hot side 17.1 of the regenerative heat exchanger 17 is further chilled in a chilling heat exchanger 19 to a temperature which causes condensation of steam contained in the exhausted flue gas. Condensing water is removed from the exhausted flue gas in a water/gas separator 21.

The de-hydrated exhausted and chilled flue gas, consisting mainly or exclusively of carbon dioxide, is compressed in a flue gas compressor 23 to the pressure at the inlet side of the expander 3. While in the schematic of FIG. 1 the flue gas compressor 23 is pictorially represented as a single compressor, in some embodiments a multiple compressor can be used. For instance, the flue gas compressor 23 can be a multi-stage compressor or a compressor train. In some embodiments, the compressor can be an intercooled compressor. In some embodiments, a main compressor can be set in series with two sequentially arranged pumps.

The compressed flue gas delivered by the flue gas compressor 23 is partly removed from the cycle through a discharge line 25. If the compressor 23 is featured by a plurality of turbomachines arranged in series, the discharge line 25 can be connected between two sequentially arranged turbomachines and/or at the discharge side of the most downstream turbomachine, for instance.

The major part of the compressed flue gas is delivered through the cold side 17.2 of the regenerative heat exchanger 17 and is heated by heat exchange with the hot flue gas flowing through the hot side 17.1 of the regenerative heat exchanger 17 and recycled to the expander 3 through a recycle line 25. The flue gas recycled through recycle line 25 is mixed with the combustion gas generated in the combustor 7, and/or with the oxidant stream from oxidant line 11.

In some embodiments, a side stream of chilled flue gas is delivered through a cooling line 27, which bypasses the regenerative heat exchanger 17, towards components of the expander 3 which require cooling.

The expander 3 may include an output shaft end 31 which can be integral with the central portion of the rotor, or can be assembled with the central portion of the rotor by bolting, welding, Hirth or spline connections, or the like, or a combination thereof. The mechanical power generated by the expansion of the combustion gas in the expansion section 5 of the expander 3 is available on the output shaft end 31 for mechanical drive or power generation purposes. In the exemplary embodiment of FIG. 1 the output shaft end 31 is drivingly coupled to an electric generator 33 directly or through a gearbox, a joint or combinations thereof. A flanged connection between the outputs shaft end 31 and the electric generator 33 is shown at 49 in FIG. 2. The electric generator 33 is in turn electrically coupled to an electric power distribution grid 35. In FIGS. 1 and 2 the output shaft end 31 is shown at the aft side of the expander 3. In other embodiments, not shown, the output shaft end 31 can be arranged at the forward side of the expander. In yet further embodiments, not shown, two output shafts ends can be provided, one at the forward side and one at the aft side of the expander.

As used herein “forward” and “aft” are referred to the direction of flow of the process gas through the expander 3. Therefore, “forward” indicates a position on the side of the combustor 7 and “aft” indicates a position on the side opposite the combustor 7, i.e., the discharge side of the expander 3.

The high pressure drop across the expander 3, the high absolute pressure in the combustor 7 and in the cooling ducts of the expanders, as well as the high torque applied to the expander shaft pose serious challenges in the design of the expander 3, in particular for high rated powers, for instance at or around 100 MW or above, such as between 100 MW and 2000 MW. The expander, and specifically the rotor design disclosed herein, can be used to achieve high power rates, preferably higher than 50 MW, for instance in the order of 100 MW o higher, for instance of 150 MW or higher, e.g. 200 MW or higher, or 300 MW or higher. In embodiments, the rated power can be lower than 2000 MW, preferably lower than 1500 MW, for instance lower than 1000 MW, or lower than 800 MW. For instance, the rated power can be comprised between 200 MW and 650 M. Intermediate values of the upper and lower limit of each range mentioned above are also expressly disclosed herein.

With continuing reference to FIG. 1, FIG. 2 illustrates a sectional view of the expander 3 in one embodiment.

In some embodiments, the expander 3 comprises an outer casing 41, which houses the combustor 7. In some embodiments the outer casing 41 includes a main body 41.1, referred to herein as a high-pressure casing, and a closure 41.2, referred to herein as a low-pressure exhaust casing. The high-pressure casing 41.1 can include a main body which can be monolithic, i.e., can consist of a single piece, for instance manufactured by forging, machining, casting, or combinations thereof. In some embodiments, the high-pressure casing 41.1 can be manufactured by welding to one another a plurality of components, preferably interfaced along a plane orthogonal to the rotation axis.

The low-pressure exhaust casing 41.2 can be positioned at the discharge side, i.e. the aft side, of the expander 3, i.e., on the side opposite the combustor 7. The low-pressure exhaust casing 41.2 can be monolithic, i.e. can consist of a single piece for instance manufactured by forging, machining, casting, or combinations thereof. In some embodiments, the low-pressure exhaust casing 41.2 can be manufactured in two or more components which can be connected irreversibly to one another, e.g., by welding, or which can be coupled to one another in a reversible manner, e.g., by means of bolts or the like. For instance, the low-pressure exhaust casing 41.2 can be split into two portions along a plane containing the rotation axis of the expander.

The high-pressure casing 41.1 and the low-pressure exhaust casing 41.2 can be connected to one another along a plane P which is orthogonal to a rotation axis A-A of a rotor 43 supported for rotation in the outer casing 41.

In some embodiments, the low-pressure exhaust casing 41.2 forms a dis-charge volute or discharge plenum 41.3, through which exhausted flue gas is discharged from the expander 3. In some embodiments, the high-pressure casing 41.1 forms seats for individual combustion chambers 7.1, cumulatively forming the combustor 7, as shown in FIG. 2.

Reference numbers 45, 47 indicate bearing arrangements, which rotatingly support the rotor 43. For instance, the bearing arrangement 45 on the side opposite the combustor 7, i.e. on the aft side, may include an axial or thrust bearing in combination with a radial bearing, or a bearing having an axial-radial bearing capability. The bearing arrangement 47 on the combustor side, i.e. on the forward side, may include a radial bearing. A reversed arrangement is also possible, with a bearing having axial load capability arranged on the combustor side. The bearing arrangements 45, 47 can be arranged in bearing casings, not shown in detail.

In some embodiments, the rotor 43 is surrounded by one or more inner casings 51, stationarily housed in the outer casing 41. If more than one inner casing is provided, the inner casings can be rigidly coupled to one another. The two or more inner casings are arranged sequentially along the axial direction of the expander and together form a single inner casing arrangement.

Each inner casing 51 can be split into two portions along a plane parallel to the rotation axis A-A of the rotor 43, for instance a plane containing the rotation axis A-A. The arrangement of one or more inner casings 51 arranged inside an outer casing 41 is particularly beneficial when the combustion gas reaches high pressures, around 200-300 barA or higher. The monolithic high-pressure casing 41.1 can withstand the loads generated by the high pressure inside the outer casing, while the inner casings 51 facilitate mounting of the stationary vanes or stationary blades, described below.

The pressure drop across the expander 3 can be around 150 bar or higher, preferably around 200 bar or higher, for instance between 250 and 400 bar. To expand the combustion gas generated in the combustor 7 a high number of expansion stages is preferred. In the exemplary embodiment of FIG. 2, the expander 3 includes eight stages. In other embodiments, a different number of expansion stages can be foreseen, preferably equal to or higher than four, more preferably equal to or higher than five. In some embodiments, the number of expansion stages can be higher than eight, for instance nine, ten, eleven or more, and preferably lower than fifteen. The expansion stages form an axial expansion flow path for the process gas being expanded in the expander 3.

Each expansion stage includes an annular row of stationary vanes or stationary blades 53 that are stationarily arranged in the expander casing 41. In the exemplary embodiment of FIG. 2, the annular rows of stationary blades are housed in the inner casings 51. Each expansion stage further includes a respective annular row of rotor blades 55, arranged downstream the respective annular row of stationary blades along the expansion flow path which extends from the combustor 7 to the discharge plenum 41.3 in a forward-to-aft direction.

In some embodiments, a first annular row of stationary blades 53.1 can be arranged at the discharge end of the combustor 7 and form an array of nozzles directing hot, high-pressure gas from the combustion chambers 7.1 of the combustor 7 to the first row of rotor blades. A first annular row of rotor blades labeled 55.1 can be arranged directly downstream of the first annular row of stationary blades 53.1 adjacent the combustor 7. A last annular row of stationary blades 53.8 can be positioned near the discharge plenum 41.3, upstream of the last annular row of rotor blades shown at 55.8. Reference number 55 generically refers to any one of the annular rows of rotor blades or to a rotor blade as such.

The rotor blades 55 form part of the rotor 43, i.e., are connected thereto for co-rotation with the rotor shaft. In embodiments, each annular row of rotor blades 55 (i.e. each row 55.i, with i=1 to 8) is connected to a respective rotor disk. The rotor disks are labeled 57.1, 57.2, 57.3, 57.4, 57.5, 57.6, 57.7 and 57.8. Reference number 57 indicates a generic rotor disk.

The rotor blades 55 can be manufactured separately from the respective rotor disk 57 and mounted thereon by suitable connection means. In other embodiments, the rotor blades 55 can be manufactured monolithically with the respective rotor disk 57, for instance by additive manufacturing. In yet further embodiments, the two design options can be combined. One or some stages may include respective monolithically manufactured components including rotor blades and disks, and one or some stages may include a rotor disk and separately manufactured rotor blades mechanically coupled to the rotor disk.

In the embodiment of FIG. 2, a first set of rotor disks comprises rotor disks 57.1, 57.2, 57.3 and 57.4. The first set of rotor disks 57.1, 57.2, 57.3, 57.4 are manufactured monolithically with a forward shaft portion 65. More specifically, in the embodiment of FIG. 2 the forward shaft portion 65 comprises a first section 65A and a second section 65B. The rotor disks 57.1, 57.2, 57.3, 57.4 of the first set of rotor disks are integrally formed with the section 65B of the forward shaft portion 65. For instance, the rotor disks 57.1, 57.2, 57.3, 57.4 and the section 65B of the forward shaft portion 65 can be formed by a single body manufactured by forging, machining, casting, or combinations thereof.

In other embodiments, the forward shaft portion 65 can be made of a monolithic body, rather than by two sections 65A, 65B. In such case, the entire forward shaft portion and the rotor disks 57.1, 57.2, 57.3, 57.4 can be manufactured monolithically as a single piece.

The annular rows of rotor blades 55.5, 55.6, 55.7 are mounted on respective additional rotor disks 57.5, 57.6, 57.7 manufactured separately from the forward shaft portion 65 and drivingly coupled thereto as described below.

In some embodiments, an additional set of rotor disks forms a single monolithic block with an aft shaft portion 67 of the rotor 43. The aft shaft portion 67 can be formed in one piece, as shown. In other embodiments, not shown, the aft shaft portion 67 can comprise two or more sections, in quite the same way as the forward shaft portion 65 and relevant sections 65A, 65B.

In the embodiment of FIG. 2, the additional set of rotor disks comprises a single rotor disk 57.8. In other embodiments, not shown, the additional set of rotor disks may include more than one rotor disk.

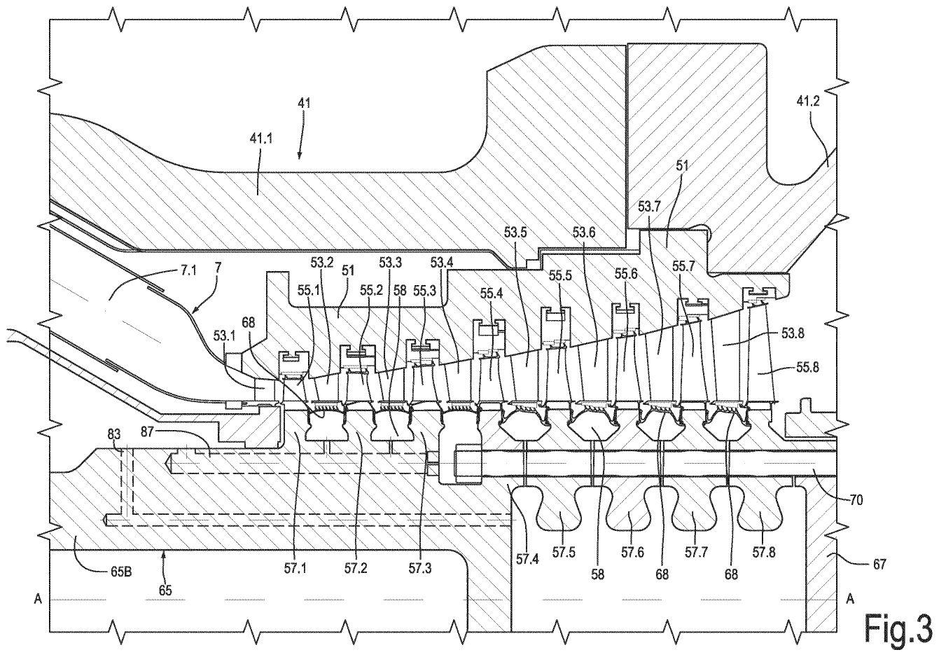

In yet further embodiments, not shown, the rotor 43 may include only the first set of rotor disks, which are monolithically formed with the forward shaft portion 65 or a section thereof, and the additional set of rotor disks monolithically formed with the aft shaft portion 67, and no intermediate disks stacked between the first set and the additional set of rotor disks. Conversely, as will described later on with reference to FIG. 3, the rotor may include rotor disks manufactured monolithically with a section of the forward shaft portion and additional single rotor disks arranged between the for-wards shaft portion and the aft shaft portion, while the latter is devoid of rotor disks formed monolithically therewith.

In embodiments, as shown in FIG. 2, the combustor 7 extends around the forward shaft portion 65. When the combustor is a can-type combustor comprising a plurality of combustion chambers 7.1 arranged around the rotation axis of the rotor 43, as shown in FIG. 2, the combustion chambers can be housed in the high-pressure casing 41.1 around the forward shaft portion 65. As shown in FIG. 2, each combustion chamber 7.1 can be housed in a seat monolithically formed in the high-pressure casing 41.1, and specifically in the forward side thereof.

In some embodiments, the discharge volute 41.3 formed by the low-pressure discharge casing 41.2 extends around the aft shaft portion 67.

The aft shaft portion 67, the forward shaft portion 65 (specifically the section 65B thereof) and the intermediate rotor disks 57.5, 57.6, 57.7 are stacked with each other and connected to one another by a tie rod arrangement. In the exemplary embodiment of FIG. 2, the tie rod arrangement comprises a plurality of tie rods 70 which are arranged around the rotation axis A-A of the rotor 43.

In other embodiments, not shown, the tie rod arrangement includes a single tie rod, coaxial with the rotor, i.e., with the rotation axis A-A.

In yet further embodiments, the tie rod arrangement can include both a central tie rod, coaxial to the rotation axis A-A, and a set of tie rods 70 arranged around the rotation axis A-A and at a radial distance therefrom, as shown in FIG. 2.

In some embodiments, each intermediate rotor disk 57.5, 57.6, 57.7 comprises front teeth on each side thereof, for torsional engagement with front teeth of the adjacent rotor disks and/or of the forward shaft portion 65 and of the aft shaft portion 67. The front teeth form Hirth joints between rotor disks 57.5 to 57.7 as well as between the first intermediate rotor disk 57.5 and the forward shaft portion 65, and between the last intermediate rotor disk 57.7 and aft shaft portion 67.

The provision of front teeth can be beneficial to increase the torque which can be transmitted from the forward shaft portion 65 to the rotor disks 57.5, 57.6, 57.7, from the rotor disk 57.7 to the aft shaft portion 67, as well as between each rotor disk 57.5, 57.6 and 57.7. In some embodiments, front teeth can be provided only in some sections of the rotor, where the torque to be transmitted is higher, i.e., in the most downstream section of the rotor 43, for instance. The region where the highest torque shall be transmitted depends on where the load is applied, i.e. whether on the aft side (opposite the combustor 7, as in the embodiment shown) or on the forward side (the side of the combustor 7) of the expander 3. Output shafts on both sides (aft and for-ward) can also be foreseen.

In some embodiments, a respective seal runner 68 is positioned between each pair of consecutive (i.e., adjacent) rotor disks 57 and seals an annular space provided radially inwardly of a respective stationary blade 53.

In some embodiments, the expander 3 comprises a balance drum drivingly coupled to the rotor 43. In the embodiment of FIG. 2, a balance drum 75 is provided at the forward end of the rotor 43, between the first expander stage and the forward bearing arrangement 47, and more specifically on the forward shaft portion 65.

In some embodiments the balance drum 75 is integrally formed with the forward shaft portion 65.

In embodiments, as shown in FIG. 2, the two sections 65A, 65B of the forward shaft portion 65 can be connected to one another by a plurality of tie rods 77, circularly arranged around the rotation axis A-A of the rotor 43. The tie rods 77 extend through holes provided in two flanges 75.1, 75.2 of the two sections 65A, 65B of the forward shaft portion 65. In this embodiment, the flanges 75.1, 75.2 cumulatively form the balance drum 75.

By splitting the balance drum into balance drum portions 75.1, 75.2, manufacturing of the balance drum, for instance by forging, is facilitated.

Cooling of the rotor 43 is performed by feeding a pressurized cooling fluid to cooling ducts formed in the rotor 43. Specifically, in some embodiments, compressed and cooled carbon dioxide can be delivered to a cooling chamber 81 in the interior of the rotor 43. The cooling chamber 81 can be formed inside the intermediate rotor disks 57.5, 57.6, 57.7 and can be closed at the aft and end forward end by the aft shaft portion 57 and by the forward shaft portion 65, respectively.

For instance, pressurized carbon dioxide delivered by the flue gas compressor 23 through cooling line 27(FIG. 1 ) can be fed in the cooling chamber 81 through ducts 83 and can flow through radial holes (not shown) in the rotor 43 to buffer and cool spaces 58 between adjacent disks 57. The ducts 83 are fluidly coupled to a cooling plenum 85, adapted to receive cooled carbon dioxide. The cooling chamber 81 provides cooling carbon dioxide to the last five stages of the expander 3. The first three stages of the expander 3 can be cooled through one or more ducts 87, which extend parallel to the rotor axis A-A and to ducts 83, and which are fluidly coupled to the cooling plenum 85. Specifically, radial cooling ducts can fluidly couple the cooling chamber with annular spaces between rotor disks 57.4 to 57.8, which are radially outwardly sealed by respective seal runners 68. Moreover, radial cooling ducts can fluidly couple each duct 87 with respective annular spaces provided between the rotor disks formed monolithically with the forward shaft portion 65, i.e. rotor disks 57.1, 57.2, 57.3 and 57.4. Also these annular spaces can be radially outwardly sealed by respective seal runners 68.

In other embodiments, not shown, a cooling chamber can be positioned in the forward shaft section 65B and radial ducts can deliver cooling duct therefrom towards the one or more annular rings of rotor blades integrally formed with the forward shaft portion 65B.

In some embodiments, for instance if the first set of rotor disks, which are monolithically manufactured with the forward shaft section 65B, comprises only one or two disks, cooling can be achieved by fluidly coupling said disks with a central cooling chamber 81 located inside the single rotor disks which are stacked between the forward shaft section 65A and the aft shaft portion 67.

The cooling fluid delivered to annular spaces between adjacent rotor disks and under the respective seal runners 68 purges the respective annular spaces and prevents process fluid from flowing therethrough. The pressure of the cooling fluid must therefore be sufficient to balance the pressure of the process fluid which expands along the expansion flow path formed by the stationary blades 53 and rotor blades 55. The pressure of the process fluid decreases along the flow path from the first to the last expander stage. The pressure of the cooling fluid needed in the most upstream expander stages is therefore very high, and can be comprised between 200 barA and 600 barA, for instance. The most upstream rotor disks, which are formed monolithically with the forward shaft portion 65, and more specifically with the section 65B thereof, provide sufficient mechanical strength to resist the high pressure which tends to separate the rotor disks from one another.

In the last stages of the expander 3, e.g. in the last four stages thereof, the pressure of the process fluid is lower and therefore also the pressure of the cooling fluid in the annular spaces between rotor disks is lower. The axial force tending to separate the rotor disks from one another due to the pressure of the cooling fluid is sufficiently small to allow separate and mutually stacked rotor disks to be assembled by tie rods 70. To provide cooling fluid at gradually decreasing pressure in the annular spaces between sequentially arranged rotor disks, the ducts through which the cooling fluid is delivered to the annular spaces can have a variable cross section, to provide a head loss, which increases from the most upstream to the most downstream expander stage, i.e. in the forward-to-aft direction.

Dividing the rotor disks into a first set of rotor disks (57.1, 57.2, 57.3 and 57.4) which are monolithically formed as one integral piece with the forward shaft portion 65 (i.e. section 65B thereof), and additional rotor disks (57.5, 57.6 and 57.7), which are stacked with the aid of tie rods 70, provides the required mechanical strength without the need to manufacture the whole rotor as a monolithic piece by forging, for instance.

The combination of monolithic and stacked rotor disks allows therefore manufacturing of large rotors, to produce expanders with high power rates. The same rotor dimensions would be difficult, if not impossible, to obtain by forging the rotor as a single piece.

While in FIG. 2 the additional set of rotor disks integral with the aft shaft portion 67 include a single rotor disk 57.8, in other embodiments, not shown, the additional set of rotor disks 57 can include a larger number of rotor disks, for instance two, three or four rotor disks integrally formed as a monolithic body with the aft shaft portion 67.

A further embodiment of a rotor, which can be used in an expander 3, is shown in a sectional view in FIG. 3. The same reference numbers indicate the same or equivalent parts shown in FIG. 2 and described above, which will not be described again.

The rotor 43 of FIG. 3 differs from the rotor shown in FIG. 2 mainly in that the rotor disks are divided into a first set of rotor disks 57.1, 57.2, 57.3 and 57.4, which are integrally formed as a monolithic block with the section 65B of the forward shaft portion 65, and separate individual rotor disks 57.5, 57.6, 57.7 and 57.8, which are all formed as separate components, arranged between the forward shaft portion 65 and the aft shaft portion 67 and stacked therewith. The forward shaft portion 65 (and more specifically the section 65B thereof), the rotor disks 57.5, 57.6, 57.7 and 57.8, and the aft shaft portion 67 are stacked to one another and mutually coupled by tie rods 70, as shown in FIG. 3, or by a different arrangement of tie rods, for instance consisting of or including a central tie rod coaxial with rotation axis A-A, as mentioned above with reference to FIG. 2. In this embodiment, there are no further rotor disks integrally formed with the aft shaft portion 67. The embodiment of FIG. 3 has the advantage, over the embodiment of FIG. 2, that the aft shaft portion is smaller and easier to manufacture by forging or other manufacturing techniques.

Exemplary embodiments have been disclosed above and illustrated in the ac-companying drawings. It will be understood by those skilled in the art that various changes, omissions and additions may be made to that which is specifically disclosed herein without departing from the scope of the invention as defined in the following claims.

For instance, while in the particularly advantageous embodiment disclosed above, the combustor is housed in the expander, in other embodiments, the combustor can be arranged outside the expander. Housing the combustor in the outer casing 41 of the expander 3 results in a more compact arrangement.

In other embodiments, the expander can be use in a close-loop thermodynamic cycle, such as a supercritical carbon dioxide cycle, where heat is introduced in the thermodynamic cycle through a heat exchanger, rather than using a combustor.

1-28. (canceled)

29. A rotor for a power-generating turbomachine, the rotor comprising:
a plurality of rotor disks; wherein each rotor disk comprises a respective annular row of rotor blades of an expansion flow path of the power-generating turbomachine;
a forward shaft portion;
an aft shaft portion; and
at least one cooling duct adapted to feed a cooling fluid to the rotor disks;
wherein:
a first set of rotor disks is formed integrally with a section of said forward shaft portion;
the first set of rotor disks and the section of forward shaft portion forming a monolithic component;
the forward shaft portion and the aft shaft portion are connected to one another by a tie rod arrangement.

30. The rotor of claim 29, wherein an additional set of rotor disks is formed integrally with the aft shaft portion; and the aft shaft portion and the additional set of rotor disks form a monolithic component.

31. The rotor of claim 29, comprising at least one additional rotor disk between the forward shaft portion and aft shaft portion; wherein the forward shaft portion, the at least one additional rotor disk and the aft shaft portion are stacked to one another and connected to one another by the tie rod arrangement.

32. The rotor of claim 29, wherein a plurality of additional rotor disks is positioned between the forward shaft portion and the aft shaft portion; and wherein the forward shaft portion, the plurality of rotor disks and the aft shaft portion are stacked to one another and connected to one another by the tie rod arrangement.

33. The rotor of claim 29, further providing a cooling chamber in the rotor, adapted to receive a cooling fluid from said cooling duct.

34. The rotor of claim 33, wherein the cooling chamber is arranged between the forward shaft portion and the aft shaft portion.

35. The rotor of claim 29, wherein radial cooling ducts are fluidly coupled with annular spaces between pairs of sequentially arranged rotor disks.

36. The rotor of claim 29, wherein the tie rod arrangement comprises: a plurality of tie rods arranged around the rotation axis of the rotor at a radial distance therefrom; a central tie rod coaxial to the rotation axis of the rotor; or a combination of a central tie rod and a plurality of tie rods arranged around the rotation axis of the rotor.

37. The rotor of claim 36, further comprising a balance drum wherein the balance drum is formed on one of said forward shaft portion and aft shaft portion, preferably on said forward shaft portion.

38. The rotor of claim 37, wherein the balance drum comprises a first balance drum portion and a second balance drum portion connected to one another through at least one tie rod and preferably through a plurality of tie rods arranged peripherally around the rotation axis of the rotor at a radial distance therefrom.

39. The rotor of claim 29, wherein at least one of said rotor disks includes frontal teeth adapted to rotationally engage said rotor disk to at least one of: an adjacent rotor disk, the forward shaft portion, and the aft shaft portion.

40. The rotor of claim 29, wherein at least one cooling duct extends in the forward shaft portion and is fluidly coupled with annular spaces between rotor disks integrally formed with the forward shaft portion.

41. The rotor of claim 29, comprising at least four, preferably at least six, more preferably at least eight expansion stages.

42. A power-generating turbomachine, comprising:
an outer casing; and
a rotor according to claim 29 housed for rotation in the casing.

43. The turbomachine of claim 42, wherein the turbomachine is an expander.

44. The turbomachine of claim 42, wherein the outer casing comprises a high-pressure casing and a low-pressure exhaust casing; wherein the high-pressure casing and the low-pressure exhaust casing are coupled along a plane orthogonal to the rotation axis.

45. The turbomachine of claim 44, wherein the high-pressure casing comprises a monolithic barrel body.

46. The turbomachine of claim 42, further comprising at least one combustor housed in the outer casing.

47. The turbomachine of claim 44, further comprising at least one inner casing, stationarily housed in the outer casing, and surrounding the rotor; wherein each inner casing is split into a first casing portion and a second casing portion along a plane parallel to the rotation axis of the rotor; and wherein the inner casing contains annular rows of stationary blades.

48. A supercritical carbon dioxide thermodynamic circuit comprising:
an oxidant source;
an expander with an inlet side and a discharge side, wherein the inlet side is fluidly coupled to the oxidant source;
a flue gas recycling line, adapted to recycle flue gas from the discharge side of the expander to a combustor of the expander;
in the flue gas recycling line, a cooler adapted to cool the flue gas from the discharge side of the expander and condense water contained in the flue gas;
a regenerative heat exchanger, wherein flue gas from the expander flows in heat exchange with chilled flue gas from the cooler;
wherein the expander is an expander according to claim 44.
